(19) United States
(12) Patent Application Publication
(10) Pub. No.: US 2025/0197768 A1
(43) Pub. Date: Jun. 19, 2025

(54) Concentrated Multi-Purpose Cleaning Composition

(71) Applicant: Colgate-Palmolive Company, New York, NY (US)

(72) Inventors: Maria Antonieta VALDES VERGARA, Mexico City (MX); Adriana ARMAS ABARCA, Mexico City (MX); Luis Javier RIVERA CRUZ, Cuautitlan Izcalli (MX); Marisol CEDOMIO, Adolfo Lopez Mateos (MX)

(73) Assignee: Colgate-Palmolive Company, New York, NY (US)

(21) Appl. No.: 18/976,986

(22) Filed: Dec. 11, 2024

Related U.S. Application Data
(60) Provisional application No. 63/609,515, filed on Dec. 13, 2023.

(51) Int. Cl. C11D 1/83; C11D 1/14; C11D 1/22; C11D 1/72; C11D 3/04; C11D 3/20; C11D 3/37; C11D 3/50

(52) U.S. Cl. CPC C11D 1/83; C11D 3/044; C11D 3/201; C11D 3/2086; C11D 3/3707; C11D 3/50; C11D 1/146; C11D 1/22; C11D 1/72

(57) ABSTRACT

Aqueous cleaning compositions and methods for making and using the same are disclosed herein. The aqueous cleaning compositions may comprise a surfactant system comprising a plurality of surfactants dispersed in an aqueous base, the plurality of surfactants comprising at least one anionic surfactant and at least one nonionic surfactant; and a plurality of viscosity modifying agents comprising ethanol, a poloxamer, or a combination thereof. The aqueous cleaning composition may have a viscosity of from about 500 cP to about 1500 cP.

### CROSS-REFERENCE TO RELATED APPLICATION

This application claims the benefit of priority from U.S. Provisional Patent Application No. 63/609,515, filed 13 Dec. 2023, the contents of which are hereby incorporated herein by reference in their entirety.

### BACKGROUND

Cleaning compositions such as light duty cleaning compositions, floor cleaners, and disinfecting products may be used for cleaning a variety of surfaces including hard surfaces. Exemplary hard surfaces include the sort found in kitchens and bathrooms, ranging from floors, toilets, sinks and work surfaces to pans and dishes. Such cleaning compositions may be formulated in solid, liquid, or gel forms, but are typically used in liquid forms (e.g., an aqueous liquid). The cleaning compositions generally include one or more surfactants, which may be nonionic surfactants, anionic surfactants, cationic surfactants, or amphoteric surfactants. The one or more surfactants may function as emulsifiers, foamers, detergents, solubilizers, and wetting agents in the cleaning compositions. While it is conventional to include a mixture or combination of various surfactants in the cleaning compositions, it is still difficult to predict what effect combining the various surfactants may have because of the wide variation in the chemical structure of each individual surfactant. For example, complexes formed between chemically different surfactants may often give rise to compositions that may be unstable and/or form precipitates, thereby rendering them undesirable for consumers.

For cleaning products or compositions, such as floor cleaners, stability (e.g., clarity and homogeneity) and viscosity are important factors contributing to consumers' perception thereof. The desired viscosity expected by the consumer should not be too thick or too thin, and the product or composition thereof should be visually appealing with respect to clarity. Other factors considered by consumers for cleaning products or compositions thereof include cleansing efficacy or performance and foam generation. Cleansing performance may be improved by improving the efficacy of the cleaning composition for oil emulsification. Improved foam generation, while minimally related to improved cleansing performance, provides a visual cue that gives consumers the impression or perception of improved cleaning performance. As such, it may be desirable for flash foam or foam generated upon agitation to be stable and in relative high volumes initially, and then decreasing to a suitable level.

Fragrance is also a key performance characteristic of cleaning compositions. When consumers compare two cleaning products, such as bucket dilutable cleaners, that have the same base formula but different fragrances, they often rate the product that has the more pleasant fragrance as a better cleaner. Consumers may also rate products with a more intense and/or longer-lasting fragrance as a better cleaner.

Additionally, providing sustainable products is quickly becoming a significant consumer demand. For example, providing products that use less plastic, less water, and/or save space is beneficial for both consumers and the environment. One way to provide for a sustainable product is to offer concentrated compositions that may be diluted by the consumer with the simple addition of water. However, aqueous cleaning compositions typically use thickening polymers to provide for appropriate viscosity, and unfortunately formulation of concentrated compositions with thickening polymers has been elusive due to the relatively high viscosity of the concentrate. Thus, the reconstituted compositions tend to exhibit poor physicochemical properties.

Nonetheless, concentrated cleaning products may provide for a variety of uses, including direct use for application directly to a surface or cleaning tool (e.g., sponge or cloth), as well as indirect use for application into water in the form of a bucket dilutable cleaner. Concentrated cleaning products may allow for reduced use of plastic containers, recyclability and reuse of plastic containers, and overall reduced carbon footprint.

In view of the foregoing, improved, affordable concentrated home care products are needed that provide acceptance viscosity, fragrance, stability, and cleaning efficacy.

### BRIEF SUMMARY

This summary is intended merely to introduce a simplified summary of some aspects of one or more implementations of the present disclosure. Further areas of applicability of the present disclosure will become apparent from the detailed description provided hereinafter. This summary is not an extensive overview, nor is it intended to identify key or critical elements of the present teachings, nor to delineate the scope of the disclosure. Rather, its purpose is merely to present one or more concepts in simplified form as a prelude to the detailed description below.

The foregoing and/or other aspects and utilities embodied in the present disclosure may be achieved by providing an aqueous cleaning composition including an aqueous base and a surfactant system, as well as a plurality of viscosity modifying agents. The surfactant system may include a plurality of surfactants dispersed in the aqueous base, and the plurality of surfactants may include one or more anionic surfactants, one or more nonionic surfactants, or a combination thereof. The plurality of viscosity modifying agents may include ethanol, a poloxamer, or a combination thereof. In certain embodiments, disclosed herein is an aqueous cleaning composition comprising: (1) a surfactant system comprising a plurality of surfactants dispersed in an aqueous base, the plurality of surfactants comprising at least one anionic surfactant and at least one nonionic surfactant; and (2) a plurality of viscosity modifying agents, the viscosity modifying agents comprising ethanol, a poloxamer, or a combination thereof.

In certain embodiments, the at least one anionic surfactant comprises an alkyl sulfonate, an alkyl ethoxy sulfate, a salt thereof, or a combination thereof, and in certain embodiments, the alkyl sulfonate comprises sodium dodecyl benzene sulfonate (DDBS). In certain embodiments, the alkyl ethoxy sulfate or salt thereof comprises sodium lauryl ether sulfate (SLES).

In certain embodiments disclosed herein, the at least one anionic surfactant is present in the composition in an amount ranging from about 1 wt % to about 20 wt %, about 2 wt % to about 18 wt %, about 4 wt % to about 16 wt %, about 6 wt % to about 14 wt %, about 8 wt % to about 12 wt %, or about 9 wt % to about 11 wt %, based on the total weight of the aqueous cleaning composition. According to certain embodiments, the DDBS is present in an amount of from about 1 wt % to about 15 wt %, about 2 wt % to about 14 wt %, about 3 wt % to about 13 wt %, about 4 wt % to about 12 wt %, about 5 wt % to about 11 wt %, about 6 wt % to about 10 wt %, about 7 wt % to about 8 wt %, about 7.5 wt %, or about 7.8 wt %, based on the total weight of the aqueous cleaning composition. In certain embodiments, the SLES is present in an amount of from about 0.1 wt % to about 10 wt %, about 0.5 wt % to about 5 wt %, about 1 wt % to about 3 wt %, about 1.5 wt % to about 2 wt %, or about 1.7 wt %, based on the total weight of the aqueous cleaning composition.

According to certain embodiments disclosed herein, the at least one nonionic surfactant comprises a reaction product of a C9-C15 or a C9-C11 alkanol and 2.5 to 10 moles of ethylene oxide, a reaction product of a C12-C13 alkanol and 6.5 moles of ethylene oxide, a reaction product of a C12-C15 alkanol and 12 moles of ethylene oxide, or a reaction product of a C14-C15 alkanol with 13 moles ethylene oxide, preferably a reaction product of a C9-C11 alkanol ethoxylated and 8 moles of ethylene oxide, further optionally, the nonionic surfactants comprise NEODOL® 91-8, and in certain embodiments, the at least one nonionic surfactant is present in in the composition in an amount ranging from about 1 wt % to about 10 wt %, about 1 wt % to about 9 wt %, about 2 wt % to about 8 wt %, about 3 wt % to about 7 wt %, about 4 wt % to about 6 wt %, about 4 wt % to about 5 wt %, or about 4.5 wt %, based on the total weight of the aqueous cleaning composition.

In certain embodiments, the surfactant system comprises or consists of a combination of sodium lauryl ether sulfate (SLES), sodium dodecyl benzene sulfonate (DDBS), and a reaction product of a C9-C11 alkanol ethoxylated and 8 moles of ethylene oxide.

In certain embodiments, the aqueous cleaning composition further comprises a fragrance, optionally present in an amount ranging from about 0.5 wt % to about 10 wt %, such as about 5 wt % to about 8 wt %, based on a total weight of the cleaning composition.

In certain embodiments of the disclosure, the aqueous cleaning composition is free of or substantially free of an amphoteric surfactant.

In certain embodiments, the ethanol is present in an amount of from about 0.2 wt % to about 1 wt %, about 0.25 wt % to about 0.8 wt %, about 0.3 wt % to about 0.7 wt %, about 0.4 wt % to 0.6 wt %, or about 0.5 wt %, based on the total weight of the aqueous cleaning composition, and in certain embodiments, the poloxamer is present in an amount of from about 0.01 wt % to about 1 wt %, about 0.15 wt % to about 0.25 wt %, about 0.175 wt % to about 0.25 wt %, about 0.25 wt % to about 0.75 wt %, or about 0.5 wt %, based on the total weight of the aqueous cleaning composition. In certain exemplary embodiments, the ethanol and the poloxamer are present in a weight ratio of from about 4:1 to about 13:1, about 7:1 to about 13:1, about 8:1 to about 12:1, about 9:1 to about 11:1, about 4:1 to about 6:1, about 5:1, or about 10:1.

In certain embodiments, the aqueous cleaning composition further comprises at least one pH modifier, such as at least one pH modifier is chosen from caustic soda, citric acid, or a combination thereof. According to certain embodiments, the caustic soda is present in an amount of from about 3 wt % to about 6 wt %, about 3.5 wt % to about 5 wt %, or about 3.8 wt %, based on the total weight of the cleaning composition, and according to certain embodiments, the citric acid is present in an amount of from about 1 wt % to about 5 wt %, such as about 1 wt % to about 2 wt %, or about 1.5 wt %, based on the total weight of the cleaning composition.

In certain embodiments, the aqueous cleaning composition may have a viscosity measured at about 25° C. of from about 500 cP to about 1500 cP.

In accordance with another aspect of the disclosure, provided is a method for preparing the aqueous cleaning composition disclosed herein comprising contacting the aqueous base, the surfactant system, and the viscosity modifying agents with one another.

### BRIEF DESCRIPTION OF THE DRAWINGS

The features, and advantages of the disclosure will be apparent from the following more detailed description of certain embodiments and as illustrated in the accompanying drawings in which:

FIG. 1 is a graph showing the percent degreasing efficacy of multiple cleaning formulations, as described in Example 3.

FIG. 2 is a graph showing the percent removal of soap scum after cleaning with multiple cleaning formulations, as described in Example 4.

FIG. 3 is a graph showing the percent residue remaining after cleaning with multiple cleaning formulations, as described in Example 5.

FIG. 4 is graph showing the foam level in mL after time for multiple cleaning formulations, as described in Example 6.

It should be understood that the various aspects are not limited to the compositions, arrangements, and instrumentality shown in the figures.

### DETAILED DESCRIPTION

For illustrative purposes, the principles of the present disclosure are described by referencing various exemplary embodiments thereof. Although certain embodiments are specifically described herein, one of ordinary skill in the art will readily recognize that the same principles are equally applicable to, and can be employed in other compositions and methods. Before explaining the disclosed embodiments in detail, it is to be understood that the disclosure is not limited in its application to the details of any particular embodiment disclosed herein. The terminology used herein is for the purpose of description and not of limitation.

As used herein and in the appended claims, the singular forms “a”, “an”, and “the” include plural references unless the context dictates otherwise. The singular form of any class of the ingredients refers not only to one chemical species within that class, but also to a mixture of those chemical species. The terms “a” (or “an”), “one or more” and “at least one” may be used interchangeably herein. The terms “comprising”, “including”, and “having” may be used interchangeably. The term “include” should be interpreted as “include, but are not limited to”. The term “including” should be interpreted as “including, but not limited to”.

As used throughout, ranges are used as shorthand for describing each and every value that is within the range. It should be appreciated and understood that the description in a range format is merely for convenience and brevity, and should not be construed as an inflexible limitation on the scope of any embodiments or implementations disclosed herein. Accordingly, the disclosed range should be construed to have specifically disclosed all the possible subranges as well as individual numerical values within that range. As such, any value within the range may be selected as the terminus of the range. For example, description of a range such as from 1 to 5 should be considered to have specifically disclosed subranges such as from 1.5 to 3, from 1 to 4.5, from 2 to 5, from 3.1 to 5, etc., as well as individual numbers within that range, for example, 1, 2, 3, 3.2, 4, 5, etc. This applies regardless of the breadth of the range.

Unless otherwise specified, all percentages and amounts expressed herein and elsewhere in the specification should be understood to refer to percentages by weight. The amounts given are based on the active weight of the material.

Additionally, all numerical values are “about” or “approximately” the indicated value, and take into account experimental error and variations that would be expected by a person having ordinary skill in the art. It should be appreciated that all numerical values and ranges disclosed herein are approximate values and ranges, whether “about” is used in conjunction therewith. It should also be appreciated that the term “about,” as used herein, in conjunction with a numeral refers to a value that may be ±0.01% (inclusive), ±0.1% (inclusive), ±0.5% (inclusive), ±1% (inclusive) of that numeral, ±2% (inclusive) of that numeral, ±3% (inclusive) of that numeral, +5% (inclusive) of that numeral, ±10% (inclusive) of that numeral, or ±15% (inclusive) of that numeral. It should further be appreciated that when a numerical range is disclosed herein, any numerical value falling within the range is also specifically disclosed.

As used herein, “free” or “substantially free” of a material may refer to a composition, component, or phase where the material is present in an amount of less than 10.0 weight %, less than 5.0 weight %, less than 3.0 weight %, less than 1.0 weight %, less than 0.1 weight %, less than 0.05 weight %, less than 0.01 weight %, less than 0.005 weight %, or less than 0.0001 weight % based on a total weight of the composition, component, or phase. In certain embodiments, if a composition is free or substantially free of a material, the material is not present in detectable quantities in the composition.

All references cited herein are hereby incorporated by reference in their entireties. In the event of a conflict in a definition in the present disclosure and that of a cited reference, the present disclosure controls.

The abbreviations and symbols as used herein, unless indicated otherwise, take their ordinary meaning. The abbreviation “wt %” or “wt. %” means percent by weight with respect to the cleaning composition, unless indicated otherwise. The symbol “∘” refers to a degree, such as a temperature degree or a degree of an angle. The symbols “h”, “min”, “mL”, “nm”, and “μm” refer to hour, minute, milliliter, nanometer, and micrometer, respectively. The abbreviation “UV-VIS” referring to a spectrometer or spectroscopy, means Ultraviolet-Visible. The abbreviation “rpm” means revolutions per minute.

When referring to chemical structures, and names, the symbols “C”, “H”, and “O” mean carbon, hydrogen, and oxygen, respectively. The symbols “-”, “=”, and “=” mean single bond, double bond, and triple bond, respectively.

“Volatile”, as used herein, means having a flash point of less than about 100° C. “Non-volatile”, as used herein, means having a flash point of greater than about 100° C.

Any member in a list of species that are used to exemplify or define a genus, may be mutually different from, or overlapping with, or a subset of, or equivalent to, or nearly the same as, or identical to, any other member of the list of species. Further, unless explicitly stated, such as when reciting a Markush group, the list of species that define or exemplify the genus is open, and it is given that other species may exist that define or exemplify the genus just as well as, or better than, any other species listed.

The phrases, “a mixture thereof,” “a combination thereof,” or a combination of two or more thereof” do not require that the mixture include all of A, B, C, D, E, and F (although all of A, B, C, D, E, and F may be included). Rather, it indicates that a mixture of any two or more of A, B, C, D, E, and F can be included. In other words, it is equivalent to the phrase “one or more elements selected from the group consisting of A, B, C, D, E, F, and a mixture of any two or more of A, B, C, D, E, and F.” Likewise, the term “a salt thereof” also relates to “salts thereof.” Thus, where the disclosure refers to “an element selected from the group consisting of A, B, C, D, E, F, a salt thereof, and a mixture thereof,” it indicates that that one or more of A, B, C, D, and F may be included, one or more of a salt of A, a salt of B, a salt of C, a salt of D, a salt of E, and a salt of F may be included, or a mixture of any two of A, B, C, D, E, F, a salt of A, a salt of B, a salt of C, a salt of D, a salt of E, and a salt of F may be included.

All components and elements positively set forth in this disclosure can be negatively excluded from the claims. In other words, the cleaning compositions of the instant disclosure can be free or essentially free of all components and elements positively recited throughout the instant disclosure. In some instances, the cleaning compositions of the present disclosure may be substantially free of non-incidental amounts of the ingredient(s) or compound(s) described herein. A non-incidental amount of an ingredient or compound is the amount of that ingredient or compound that is added into the cleaning composition by itself. For example, a cleaning composition may be substantially free of a non-incidental amount of an ingredient or compound, although such ingredient(s) or compound(s) may be present as part of a raw material that is included as a blend of two or more compounds.

Some of the various categories of components identified may overlap. In such cases where overlap may exist and the cleaning composition includes both components (or the composition includes more than two components that overlap), an overlapping compound does not represent more than one component. For example, certain compounds may be characterized as both a pH modifying agent and an antibacterial agent. If a particular cleaning composition includes both a pH modifying agent and an antibacterial agent, a particular compound will serve only as either the a pH modifying agent or an antibacterial agent—not both.

For readability purposes, the chemical functional groups are in their adjective form; for each of the adjectives, the word “group” is assumed. For example, the adjective “alkyl” without a noun thereafter, should be read as “an alkyl group.”

The aqueous cleaning compositions disclosed herein may be or include a cleaning product. For example, the aqueous cleaning composition may be a cleaning product including the cleaning composition and/or one or more additional ingredients/components. As used herein, the expression “cleaning product” may refer to a final form that is sold to a consumer. The aqueous cleaning composition may be a liquid, a fluid, a gel, or the like. Illustrative cleaning compositions may be or include, but are not limited to, a home care product, such as a hard surface cleaner (e.g., floor cleaner); a hand dishwashing product, such as a liquid or gel hand dishwashing product; and a product for cleaning and/or disinfecting kitchen, bathroom, or other surfaces.

As used herein, a “cleaning composition” or “aqueous cleaning composition” may refer to any composition that may be used for cleaning a substrate or a surface thereof. A “surface” may refer to hard surfaces, including, but not limited to, floors, kitchen surfaces, such as counter tops, stove tops, dishes, sinks, and cabinets, walls, appliances (e.g., kitchen appliances, bathroom appliances, etc.), fixtures (e.g., sinks, toilets, bathtubs, tiles, doors, etc.), or any other hard surfaces commonly found in the household. The surface may be or include, but is not limited to, the surface of wood, laminate, ceramic, plastic, glass, floors (e.g., both wood and laminate), dishes, furniture, textiles or fabrics (e.g., clothes, carpets or rugs, cloths, bedding, leather, etc.), sponges, mops, or the like, or a combination thereof. The surface may also include polymeric surfaces, fibrous surfaces, surfaces of objects fabricated from natural or synthetic materials (e.g., protective gear, sports equipment, etc.). Accordingly, the present cleaning composition may form a portion or a basis of, be incorporated into, and/or be used as a hard surface cleaner, a spray cleaner, a floor cleaner, a microwave cleaner, a stovetop cleaner, an oven cleaner, or the like, or a combination thereof. As used herein, the term “dishes” refers to dishes as well as other tools and utensils involved in the preparation and/or consumption of food.

The cleaning compositions disclosed herein may be an aqueous cleaning composition. The aqueous cleaning composition may include an aqueous base or carrier, a surfactant system including one or more surfactants, one or more viscosity modifying agents, one or more excipients, or a combination thereof. The aqueous cleaning composition may be formulated to be visibly clear or opaque and homogenous after exposure to aging or cooling conditions (e.g., about 5° C.). For example, the aqueous cleaning composition may include a plurality of surfactants and/or viscosity modifying agents in relative formulated amounts to provide a visibly opaque and homogenous composition after exposure to aging or cooling conditions.

The aqueous cleaning composition may be formulated to provide a pourable viscosity in an undiluted and/or diluted form. For example, the aqueous cleaning composition may have a viscosity measured at about 25° C. of from about 500 cP to about 2,000 cP. For example, the aqueous cleaning composition may have a viscosity measured at about 25° C. of from about 500 cP, about 600 cP, about 700 cP, about 750 cP, about 800 cP, about 850 cP, or about 900 cP to about 950 cP, about 1,000 cP, about 1,100 cP, about 1,200 cP, about 1,300 cP, about 1,600 cP, about 1,800 cP, or about 2,000 cP. In another example, the aqueous cleaning composition may have a viscosity measured at about 25° C. of from about 500 cP to about 2,000 cP, about 500 to about 1,500 cP, about 500 cP to about 1,200 cP, or about 500 cP to about 950 cP.

The surfactant system may be capable of or configured to facilitate the removal of soil, dirt, oil, debris, grease, or the like, from surfaces. The surfactant system may include a plurality of surfactants, including one or more anionic surfactants, one or more nonionic surfactants, or a combination thereof. The surfactant system may represent the amount or concentration of active ingredients (AI) in the cleaning composition. The surfactant system may be present in an amount of from about 10 wt % to about 20 wt %, about 11 wt % to 19 wt %, about 12 wt % to 18 wt %, about 13 wt % to 17 wt %, about 14 wt % to 16 wt %, about 14 wt % to 15 wt %, or about 14 wt %, based on the total weight of the aqueous cleaning composition. Accordingly, the aqueous cleaning composition may include active ingredients in an amount of from about 10 wt % to about 20 wt %, about 11 wt % to 19 wt %, about 12 wt % to 18 wt %, about 13 wt % to 17 wt %, about 14 wt % to 16 wt %, about 14 wt % to 15 wt %, or about 14 wt %, based on the total weight of the aqueous cleaning composition. The surfactant system may also be capable of or configured to provide: a relatively lower cloud point, improved stability, increased flash foam, improved oil emulsification, improved contact angle on soiled surfaces, improved soap scum removal efficacy, improved degreasing efficacy, improved residue removal efficacy, or a combination thereof. For example, each of the plurality of surfactants in the surfactant system may be varied or modified (e.g., increased or decreased) with respect to weight ratios and/or concentration to provide: a relatively lower cloud point, improved stability, increased flash foam, improved oil emulsification, improved contact angle on soiled surfaces, improved soap scum removal efficacy, improved degreasing efficacy, improved residue removal efficacy, or a combination thereof.

The at least one anionic surfactant may be or include, but is not limited to, an alkyl sulfonate, an alkyl ethoxy sulfate, or a salt thereof, or a combination thereof. The alkyl sulfonate may be or include a branched or linear alkyl benzene sulfonate, optionally, magnesium linear alkyl benzene sulfonate, sodium linear alkyl benzene sulfonate, or triethanolamine linear alkyl benzene sulfonate. In an exemplary implementation, the linear alkyl benzene sulfonate includes dodecyl benzene sulfonate, such as sodium dodecyl benzene sulfonate. The alkyl ethoxy sulfate may also be or include a fatty acid ethoxylate sulfate, optionally C12-C15 alkyl ethoxysulfate with 1-3 ethoxylate (EO) groups per molecule, or a salt thereof. In an exemplary implementation, the fatty acid ethoxylate sulfate may be or include ammonium laureth sulfate, sodium lauryl ether sulfate (SLES), also referred to as sodium laureth sulfate, or a combination thereof. The sodium lauryl ether sulfate may have an average of about 1 to about 10 moles of ethylene oxide per mole, or about 1 to 3 moles of ethylene oxide per mole, or about 2 to about 3 moles of ethylene oxide per mole. Illustrative anionic surfactants may be or include, but are not limited to, sodium lauryl sulfate, sodium laureth sulfate, sodium cocoyl monoglyceride sulfonate, sodium lauryl sarcosinate, sodium lauryl isoethionate, sodium laureth carboxylate, sodium dodecyl benzenesulfonate (DDBS), or a combination thereof. In an exemplary implementation, the one or more anionic surfactants include at least sodium lauryl ether sulfate (SLES) and sodium dodecyl benzenesulfonate (DDBS).

The one or more anionic surfactants may be present in an amount of from about 1 wt % to about 20 wt %, about 2 wt % to about 18 wt %, about 4 wt % to about 16 wt %, about 6 wt % to about 14 wt %, about 8 wt %, about 12 wt %, about 9 wt % to about 11 wt %, about 10.5 wt %, or about 9.5 wt %, based on the total weight of the aqueous cleaning composition. In an exemplary implementation, the one or more anionic surfactants include at least sodium lauryl ether sulfate (SLES) and sodium dodecyl benzenesulfonate (DDBS). The combination of SLES and DDBS may be present in an amount of from about 1 wt % to about 20 wt %, about 2 wt % to about 18 wt %, about 4 wt % to about 16 wt %, about 6 wt % to about 14 wt %, about 8 wt % to about 12 wt %, about 9 wt % to about 10 wt %, about 10.5 wt %, or about 9.5 wt %, based on the total weight of the aqueous cleaning composition. The SLES may be present in an amount of from about 0.1 wt % to about 10 wt %, about 0.5 wt % to about 5 wt %, about 1 wt % to about 3 wt %, about 1.5 wt % to about 2 wt %, or about 1.7 wt %, based on the total weight of the aqueous cleaning composition. The DDBS may be present in an amount of from about 1 wt % to about 15 wt %, about 2 wt % to about 14 wt %, about 3 wt % to about 13 wt %, about 4 wt % to about 12 wt %, about 5 wt % to about 11 wt %, about 6 wt % to about 10 wt %, about 7 wt % to about 8 wt %, about 7.5 wt %, or about 7.8 wt %, based on the total weight of the aqueous cleaning composition. The weight ratio of the SLES to the DDBS may be from about 1:1 to about 1:6, about 1:2 to about 1:5, about 1:3 to about 1:5, about 1:4 to about 1:4.8, about 1:4.4 to about 1:4.6, or about 1:4.6.

The one or more nonionic surfactants may be or include, but are not limited to, the condensation products of a higher alcohol (e.g., an alkanol containing about 8 to 18 carbon atoms in a straight or branched chain configuration) condensed with about 5 to 30 moles of ethylene oxide, for example, lauryl or myristyl alcohol condensed with about 16 moles of ethylene oxide (EO), tridecanol condensed with about 6 to moles of EO, myristyl alcohol condensed with about 10 moles of EO per mole of myristyl alcohol, the condensation product of EO with a cut of coconut fatty alcohol containing a mixture of fatty alcohols with alkyl chains varying from 10 to about 14 carbon atoms in length and wherein the condensate contains either about 6 moles of EO per mole of total alcohol or about 9 moles of EO per mole of alcohol and tallow alcohol ethoxylates containing 6 EO to 11 EO per mole of alcohol.

The one or more nonionic surfactants may also be or include, but are not limited to, a higher aliphatic, C9-C15 primary alcohol or alkanol. For example, the nonionic surfactants may be a reaction product (e.g., a condensation product) of C9-C15 or C9-C11 alkanol and 2.5 to 10 moles of ethylene oxide, C12-C13 alkanol and 6.5 moles of ethylene oxide, C12-C15 alkanol and 12 moles of ethylene oxide, C14-C15 alkanol with 13 moles ethylene oxide, or the like. For example, the nonionic surfactants may be or include, but are not limited to, NEODOL® 91-2.5, 91-5, 91-6, 91-8, or 91-8.4, NEODOL® 23-6.5, NEODOL® 25-12, NEODOL® 45-13, NEODOL® 135, NEODOL® 67, or the like, or a combination thereof, all of which are commercially available from Shell Corp. of Houston, TX. NEODOL® is a tradename of Shell Corp. of Houston, TX for its alcohol ethoxylate surfactants. Other exemplary non-ionic surfactants may include Sasol's Marlipal or Alfonic 10-8 Ethoxylate. Other suitable nonionic surfactants are described in International Publication WO 2007/001593 to The Clorox Company, and U.S. Pat. No. 6,342,473 to Kott et al., the disclosures of which are incorporated herein by reference. In an exemplary implementation, the one or more nonionic surfactants include at least one NEODOL® surfactant or at least one higher aliphatic, primary alcohol. In a particular implementation, the one or more nonionic surfactants include NEODOL® 91-8 (CAS No. 68439-46-3), a high purity C9-C11 alcohol ethoxylated with 8 moles of ethylene oxide per mole of alcohol (C9-11 Alcohol Ethoxylate, 8 EO). In a particular implementation, the one or more nonionic surfactants include a C9-11 alcohol, 7.5-8:1 EO.

The nonionic surfactants may be present in an amount of from about 1 wt % to about 10 wt %, about 1 wt % to about 9 wt %, about 2 wt % to about 8 wt %, about 3 wt % to about 7 wt %, about 4 wt % to about 6 wt %, about 4 wt % to about 5 wt %, or about 4.5 wt %, based on the total weight of the aqueous cleaning composition. In an exemplary implementation, the nonionic surfactants include C9-11 alcohol, 7.5-8:1 EO, e.g., NEODOL® 91-8 (CAS No. 68439-46-3), a high purity C9-C11 alcohol ethoxylated with 8 moles of ethylene oxide per mole of alcohol (C9-11 Alcohol Ethoxylate, 8 EO) in an amount of from about 1 wt % to about 10 wt %, about 1 wt % to about 9 wt %, about 2 wt % to about 8 wt %, about 3 wt % to about 7 wt %, about 4 wt % to about 6 wt %, about 4 wt % to about 5 wt %, or about 4.5 wt %, based on the total weight of the aqueous cleaning composition.

The total weight ratio of the anionic surfactants to the nonionic surfactants may be from about 0.5:1 to about 10:1, about 1:1 to about 5:1, about 1.5:1 to about 3:1, about 2:1 to about 3:1, about 2:1, or about 2.1:1. The weight ratio of nonionic surfactant(s) to SLES may be from about 0.5:1 to about 5:1, about 1:1 to about 4.5:1, about 1.5:1 to about 4:1, about 2:1 to about 3.5:1, about 2.5:1 to about 3:1, or about 2.2:1 to about 2:8:1, or about 2.6:1. The weight ratio of the DDBS to nonionic surfactant(s) may be from about 0.5:1 to 5:1, about 0.8:1 to about 4:1, about 1:1 to about 3:1, about 1.5:1 to about 2:1, about 1.5:1 to about 1.7:1, or about 1.6:1.

In at least one implementation, the surfactant system includes one or more of SLES, DDBS, C9-11 ethoxylated alcohol, or a combination thereof. For example, the surfactant system includes a combination of SLES, DDBS, and C9-11 ethoxylated alcohol. The combination of DDBS, C9-11 ethoxylated alcohol, and SLES may be present in a weight ratio of about 4.6 to about 2.6 to about 1 (4.6:2.6:1), respectively. The combination of SLES, DDBS, and C9-10 ethoxylated alcohol may be present in an amount of from about 5 wt % to about 25 wt %, about 8 wt % to 20 wt %, about 10 wt % to 18 wt %, about 12 wt % to 16 wt %, about 13 wt % to 15 wt %, about 14 wt %, based on the total weight of the aqueous cleaning composition.

The aqueous base or carrier may be capable of or configured to store, entrain, or otherwise contain the surfactant system. The carrier may be or include, but is not limited to, any one or more of solvents, fragrances, enzymes, polymers, water, emulsifying agents, thickeners, colorants, natural actives or extracts, antimicrobial agents, pH modifying agents (e.g., acids, bases, and/or buffers), dyes, preservatives, chelating agents, viscosity modifying agents, salts, or the like, or any mixture or combination thereof, in addition to any one or more of the other carrier components disclosed herein.

The solvents may include any water soluble solvents, such as those that may be capable of or configured to act as a hydrotrope. Water soluble solvents include, but are not limited to, C2-4 mono, dihydroxy, or polyhydroxy alkanols and/or an ether or diether, such as ethanol, isopropanol, diethylene glycol monobutyl ether, dipropylene glycol methyl ether, diproyleneglycol monobutyl ether, propylene glycol n-butyl ether, propylene glycol, hexylene glycol, propanediol, and alkali metal cumene, alkali metal toluene, or alkali metal xylene sulfonates, such as sodium cumene sulfonate and sodium xylene sulfonate (SXS). In an exemplary implementation, the solvents include may include ethanol and diethylene glycol monobutyl ether, both of which are miscible with water. Urea can be optionally used at a concentration of 0.1% to 7 weight %.

Water of the aqueous cleaning composition or the carrier thereof may be deionized water, demineralized water, and/or softened water. Water may make up the balance of the cleaning composition. For example, the amount of water in the cleaning composition may be from about 10 wt % to 90 wt %, about 40 wt % to about 85 wt %, or about 60 wt % to about 80 wt %. In another example, the amount of water in the cleaning composition may be at least 60 wt %, at least 65 wt %, at least 68 wt %, at least 69 wt %, at least 70 wt %, at least 71 wt %, at least 72 wt %, or at least 73 wt %. In certain embodiments, the amount of water in the cleaning composition may be less than 95 wt %, such as less than 90 wt %, less than 85 wt %, less than 80 wt %, or less than 75 wt %. In certain embodiments, the amount of water in the cleaning composition may range from about 60 wt % to about 90 wt %, such as from about 65 wt % to about 85 wt %, about 70 wt % to about 80 wt %, about 72 wt % to about 76 wt %, or about 73 wt % to about 74 wt %. The amount of water in the cleaning composition may include free water added and water introduced with other components or materials of the cleaning composition. For example, the amount of the water in the cleaning composition may include free water and water associated with the surfactants or any other component of the cleaning composition.

In certain embodiments, the cleaning composition may also be a concentrate. In certain embodiments of the cleaning composition disclosed herein, the customer, or an intermediate party, may dilute a concentrate with water to obtain a suitable solution, such as a solution having about 10%, about 15%, about 20%, about 25%, about 30%, about 40%, about 50%, about 60%, about 70%, about 80%, or about 90% of the initial concentrate concentration.

The one or more viscosity modifying agents may be capable of or configured to modify (e.g., increase or decrease) a viscosity of the aqueous cleaning composition. In at least one implementation, the viscosity modifying agent may be or include a polymer, such as a poloxamer. The poloxamer may be a liquid or a paste. The poloxamer may be or include a block copolymer. For example, the poloxamer may be or include a poly(ethylene glycol)-poly(propylene glycol)-poly(ethylene glycol) block copolymer (PEG-PPG-PEG), such as, poly(ethylene glycol)-block-poly(propylene glycol)-block-poly(ethylene glycol). The poloxamer may have an average molecular weight of less than or equal to about 12,000 Dalton (Da), less than or equal to about 11,000 Da, less than or equal to about 10,000 Da, less than or equal to about 9,000 Da, less than or equal to about 8,000 Da, less than or equal to about 7,000 Da, or less than or equal to about 6,000 Da. Illustrative poloxamers may be or include, but are not limited to, one or more of PLURONIC® L35, PLURONIC® L43, PLURONIC® L64, PLURONIC® L10, PLURONIC® L44 (CAS No. 9003-11-6), PLURONIC® L62, PLURONIC® 10R5, PLURONIC® 17R4, PLURONIC® L25R4, PLURONIC® P84, PLURONIC® P65, PLURONIC® P104, and PLURONIC® P105, or the like, or any mixture or combination thereof, each of which or commercially available from BASF Corp. of Florham Park, NJ. In certain embodiments, the polymer includes poloxamer 124 or PLURONIC® L44 (CAS No. 9003-11-6).

In at least one implementation, one or more of the solvents may act as a viscosity modifying agent. For example, ethanol may be included in the aqueous cleaning composition as a solvent and a viscosity modifying agent. In an exemplary implementation, the viscosity modifying agents include a combination of ethanol and one or more poloxamers.

In at least one implementation, each of the viscosity modifying agents may be present in an amount effective to provide a viscosity of from about 500 cP to about 1500 cP measured at about 25° C. Each of the viscosity modifying agents may also be present in an amount effective to provide a cloud point less than 5° C., less than 4° C., less than 3° C., less than 2° C., less than 1° C., or less than 0° C. Each of the viscosity modifying may also be present in an amount effective to improve stability of the cleaning composition, reduce turbidity of the cleaning composition, maintain clarity of the cleaning composition, recover clarity of the cleaning composition after exposure to cooling conditions, improve degreasing efficacy, improve soap scum removal efficacy, improve residue removal efficacy, improve the fragrance, or a combination thereof. In an exemplary implementation, the viscosity modifying include a combination of ethanol and one or more poloxamers. The amount and/or weight ratio of the ethanol and the poloxamer may be modified to modify the viscosity of the cleaning composition, improve stability of the cleaning composition, reduce turbidity of the cleaning composition, maintain clarity of the cleaning composition, recover clarity of the cleaning composition after exposure to cooling conditions, improve degreasing efficacy, improve soap scum removal efficacy, improve residue removal efficacy, improve the fragrance, or a combination thereof.

The ethanol may be present in an amount of from about 0.2 wt % to about 1 wt %, about 0.25 wt % to about 0.8 wt %, about 0.3 wt % to about 0.7 wt %, about 0.4 wt % to 0.6 wt %, or about 0.5 wt %, based on the total weight of the cleaning composition. The poloxamer may be present in an amount of from about 0.01 wt % to about 1 wt %, about 0.15 wt % to about 0.25 wt %, about 0.175 wt % to about 0.25 wt %, about 0.25 wt % to about 0.75 wt %, or about 0.5 wt %, based on the total weight of the cleaning composition. The weight ratio of ethanol to the poloxamer in the viscosity modifying agents may be from about 4:1 to about 13:1, about 7:1 to about 13:1, about 8:1 to about 12:1, about 9:1 to about 11:1, about 4:1 to about 6:1, about 5:1, or about 10:1.

It should be appreciated by one having ordinary skill in the art that the cleaning compositions disclosed herein may include other additional ingredients/components. For example, the cleaning composition may include any one or more additional ingredients to provided added effects or to make the product more attractive to a consumer. Illustrative additional ingredients may be or include, but are not limited to, perfumes, fragrances, abrasive agents, disinfectants, radical scavengers, bleaches, acids, chelating agents, antibacterial agents/preservatives, pH modifying agents, colorants, optical brighteners, or a combination thereof.

In at least one implementation, the cleaning composition may include one or more acids, one or more bases, and/or one or more buffers or buffering agents configured to adjust or control the pH of the cleaning composition. The one or more acids, one or more bases, and/or one or more buffers may, separately and independently, be present in an amount of from greater than 0 wt % to less than or equal to about 10 wt %, less than or equal to about 8 wt %, less than or equal to about 6 wt %, less than or equal to about 5 wt %, less than or equal to about 4 wt %, less than or equal to about 2 wt %, less than or equal to about 1 wt %, less than or equal to about 0.6 wt %, less than or equal to about 0.5 weight %, or less than or equal to about 0.4 wt %, based on a total weight of the cleaning composition, such as in an amount of from about 3 wt % to about 6 wt %, about 3.5 wt % to about 5 wt %, or about 3.8 wt %. In certain embodiments, the one or more acids, one or more bases, and/or one or more buffers may, separately and independently, be present in an amount of about 1 wt % to about 5 wt %, such as about 1 wt % to about 2 wt %, or about 1.5 wt %.

Illustrative bases may include, but are not limited to, ammonia; mono-, di-, and tri-alkyl amines; mono-, di-, and tri-alkanolamines; alkali metal and alkaline earth metal hydroxides; sodium hydroxide (caustic soda), potassium hydroxide, lithium hydroxide, monoethanolamine, triethylamine, isopropanolamine, diethanolamine, triethanolamine, or the like, or combinations thereof. Illustrative acids may include, but are not limited to, mineral acids, such as hydrochloric acid, nitric acid, phosphoric acid, and sulfuric acid, polycarboxylic and/or organic acids, such as citric acid, acetic acid, lactic acid, glycolic acid, formic acid, butyric acid, propionic acid, valeric acid, malic acid, oxalic acid, carbonic acid, taurine, or the like, or combinations thereof. In certain embodiments, the cleaning composition is free of sulfuric acid. In certain embodiments, the cleaning composition comprises caustic soda as a pH modifying agent, such as about 2 wt % to about 5 wt %, about 3 wt % to about 4 wt %, or about 3.8 wt % caustic soda. In certain embodiments, the cleaning composition comprises citric acid as a pH modifying agent, such as about 0.5 wt % to about 3 wt %, about 1 wt % to about 2 wt %, or about 1.5 wt % caustic soda.

The cleaning compositions may, in some cases, comprise one or more preservatives. Illustrative preservatives may be or include, but are not limited to, benzalkonium chloride; benzethonium chloride, 5-bromo-5-nitro-1,3dioxane; 2-bromo-2-nitropropane-1,3-diol; alkyl trimethyl ammonium bromide; N-(hydroxymethyl)-N-(1,3-dihydroxy methyl-2,5-dioxo-4-imidaxolidinyl-N′-(hydroxy methyl) urea; 1-3-dimethyol-5,5-dimethyl hydantoin; formaldehyde; glutaraldehyde, iodopropynl butyl carbamate, butyl paraben; ethyl paraben; methyl paraben; propyl paraben, mixture of methyl isothiazolinone/methyl-chloroisothiazoline in a 1:3 wt. ratio; mixture of phenoxythanol/butyl paraben/methyl paraben/propylparaben; 2-phenoxyethanol; tris-hydroxyethyl-hexahydrotriaz-ine; methylisothiazolinone; 5-chloro-2-methyl-4-isothiazolin-3-one; 1,2-dibromo-2,4-dicyanobutane; 1-(3-chloroalkyl)-3,5,7-triaza-azoniaadam-antane chloride; sodium benzoate, benzylisothiazolinone, organic acids, such as lactic acid, or a combination thereof.

The cleaning composition may be formulated to have preservative(s) in an amount from about 0.01 wt % to about 12 wt %, based on the total weight of the cleaning composition. For example, the preservative(s) may be present in the cleaning composition in an amount from about 0.01 wt % to about 12 wt %, about 0.01 wt % to about 10 wt %, about 0.01 wt % to about 8 wt %, about 0.01 wt % to about 6 wt %, about 0.01 wt % to about 4 wt %, about 0.01 wt % to about 3 wt %, about 0.01 wt % to about 2 wt %, about 0.01 wt % to about 1 wt %; from about 0.1 wt % to about 12 wt %, about 0.1 wt % to about 10 wt %, about 0.1 wt % to about 8 wt %, about 0.1 wt % to about 6 wt %, about 0.1 wt % to about 4 wt %, about 0.1 wt % to about 3 wt %, or 0.09 wt %, or any range or subrange thereof, based on the total weight of the cleaning composition.

The preservative system may, in some cases, include or exclude one or more of the following preservatives: chlorhexidine, chlorhexidine digluconate, chlorhexidine dihydrochloride, chlorhexidine diacetate, chlorhexidine gluconate, chlorhexidine hydrochloride, chlorhexidine phosphanilate, chlorphensin, benzoic acid or a salt or ester thereof (e.g., sodium benzoate), propionic acid or a salt thereof, salicylic acid or a salt thereof, sorbic acid or a salt thereof (e.g. potassium sorbate), formaldehyde, paraformaldehyde, zinc pyrithione, inorganic sulphites, hydrogen sulphites, chlorobutanol, 4-hydroxybenzoic acid or a salt or ester thereof (e.g. methylparaben, ethylparaben, propylparaben), dehydroacetic acid and/or a salt thereof (e.g. sodium dehydroacetate), formic acid or a salt thereof, dibromohexamidine isethionate; thimerosal, phenylmecuric salts, undecylenic acid or a salt thereof, hexetidine, bronopol, 5-bromo-5-nitro-1,3-dioxane, dichlorobenzyl alcohol, benzyl alcohol, triclocarban, chlororesol, triclosan, chloroxylenol, imidazolidinyl urea, polyaminopropyl biguanide, phenoxyethanol, methenamine, quaternium-15, climbazole, DMDM hydantoin, 1-hydroxy-4-methyl-6-(2,4,4-trimethylenepentyl)-2 pyridon, piroctone olamine, bromochlorophene, 0-cymen-5-ol, methylchloroisothiazolinone, methylisothiazololinone, mixtures of methylchloroisothiazolinone and methylisothiazololinone, chlorophene, chloroacetamide, phenoxyisoproponol, alkyl (C₁₂-C₂₂) trimethyl ammonium bromide, alkyl (C₁₂-C₂₂) trimethyl ammonium chloride, dimethyl oxazolidine, diazolidinyl urea, hexamidine, hexamidine diisethionate, hexamidine diparaben, hexamidine paraben, glutaral, 7-ethylbicyclooxazolidine, sodium hydroxymethylaminoacetate, silver chloride, benzethonium chloride, benzalkonium chloride, benzalkonium bromide, benzalkonium saccharinate, benzylhemiformal, iodopropynyl butylcarbamate, silver citrate, or a combination of two or more thereof.

The chelating agents may be or include, but are not limited to, glutamic acid, N,N-diacetic acid, tetra sodium salt, e.g., Dissolvine® GL-47-S(CAS Number 51981-21-6), diethylenetriamine pentaacetate (DTPA), ethylenediamine tetraacetic acid (EDTA), etidronic acid, iminodisuccinate, or the like, or a combination thereof.

The cleaning composition may include one or more fragrances. The amount of fragrances present in the cleaning composition may be from about 0.1 wt % to about 10 wt %, about 0.1 wt % to about 9 wt %, about 0.1 wt % to about 8 wt %, about 0.1 wt % to about 7 wt %, about 0.1 wt % to about 8 wt %; from about 0.5 wt % to about 10 wt %, about 1 wt % to about 9 wt %, about 1 wt % to about 8 wt %, about 1 wt % to about 7 wt %, about 1 wt % to about 6 wt %; from about 2 wt % to about 10 wt %, about 2 wt % to about 9 wt %; about 2 wt % to about 8 wt %, about 2 wt % to about 7 wt %, about 2 wt % to about 6 wt %; from 3 wt % to about 10 wt %, about 3 wt % to about 9 wt %; about 3 wt % to about 8 wt %, about 3 wt % to about 7 wt %, about 3 wt % to about 6 wt %; from about 4 wt % to about 10 wt %, about 4 wt % to about 9 wt %; about 4 wt % to about 8 wt %, about 4 wt % to about 7 wt %, about 4 wt % to about 6 wt %; from about 5 wt % to about 10 wt %; about 5 wt % to about 8 wt %, about 5 wt % to about 7 wt %, about 5 wt % to about 6 wt %; or about 5.8 wt %, including any range or subrange therebetween, based on the total weight of the cleaning composition.

Non-limiting examples of fragrances and perfumes include odor compounds selected from: 7-acetyl-1,2,3,4,5,6,7,8-octahydro-1,1,6,7-tetramethylnaphthalene, α-ionone, β-ionone, γ-ionone α-isomethylionone, methylcedrylone, methyl dihydrojasmonate, methyl 1,6,10-trimethyl-2,5,9-cyclododecatrien-1-yl ketone, 7-acetyl-1,1,3,4,4,6-hexamethyltetralin, 4-acetyl-6-tert-butyl-1,1-dimethylindane, hydroxyphenylbutanone, benzophenone, methyl β-naphthyl ketone, 6-acetyl-1,1,2,3,3,5-hexamethylindane, 5-acetyl-3-isopropyl-1,1,2,6-tetramethylindane, 1-dodecanal, 4-(4-hydroxy-4-methylpentyl)-3-cyclohexene-1-carboxaldehyde, 7-hydroxy-3,7-dimethyloctanal, 10-undecen-1-al, isohexenylcyclohexylcarboxaldehyde, formyltricyclodecane, condensation products of hydroxycitronellal and methyl anthranilate, condensation products of hydroxycitronellal and indole, condensation products of phenylacetaldehyde and indole, 2-methyl-3-(para-tert-butylphenyl) propionaldehyde, ethylvanillin, heliotropin, hexylcinnamaldehyde, amylcinnamaldehyde, 2-methyl-2-(isopropylphenyl) propionaldehyde, coumarin, γ-decalactone, cyclopentadecanolide, 16-hydroxy-9-hexadecenoic acid lactone, 1,3,4,6,7,8-hexahydro-4,6,6,7,8,8-hexamethylcyclopenta-γ-2-benzopyran, β-naphthol methyl ether, ambroxane, dodecahydro-3a,6,6,9a-tetramethylnaphtho[2,1b] furan, cedrol, 5-(2,2,3-trimethylcyclopent-3-enyl)-3-methylpentan-2-ol, 2-ethyl-4-(2,2,3-trimethyl-3-cyclopenten-1-yl)-2-buten-1-ol, caryophyllene alcohol, tricyclodecenyl propionate, tricyclodecenyl acetate, benzyl salicylate, cedryl acetate, and tert-butylcyclohexyl acetate.

Other fragrances may include odor compounds selected from essential oils, resinoids and resins from a large number of sources, such as, for example, Peru balsam, olibanum resinoid, styrax, labdanum resin, nutmeg, cassia oil, benzoin resin, coriander, and lavandin.

Further examples of fragrances include odor compounds selected from phenylethyl alcohol, terpineol, linalool, linalyl acetate, geraniol, nerol, 2-(1,1-dimethylethyl)cyclo-hexanol acetate, benzyl acetate, and eugenol. The fragrances or perfumes can be used as single substances or in a mixture with one another.

In certain embodiments, the aqueous cleaning composition disclosed herein further comprises at least one emulsifying agent, e.g., a salt, that can optionally aid in emulsifying the components of the aqueous cleaning composition, e.g., a fragrance. The at least one emulsifying agent can be chosen from any emulsifying agent known in the art, including, for example, an alcohol solvent as described above and salts such as sodium chloride, magnesium chloride, magnesium sulfate, calcium chloride, potassium sulfate, lactate salts, and citrate salts, among others. In certain embodiments, the cleaning composition further comprises at least one salt selected from sodium chloride, magnesium chloride, magnesium sulfate, calcium chloride, potassium sulfate, lactate salts, and citrate salts. In certain embodiments, the at least one salt is sodium chloride. The at least one salt may be present in the aqueous cleaning composition in an amount ranging from greater than 0 to about 3 wt %, such as about 0.1 wt % to about 2 wt %, about 0.15 wt % to about 1 wt %, about 0.25 wt % to about 0.75 wt %, about 0.15 wt %, about 0.25 wt %, about 0.3 wt %, about 0.4 wt %, about 0.5 wt %, about 0.6 wt %, about 0.75 wt %, or about 1 wt %.

The cleaning compositions disclosed herein may further comprise one or more colorants. The colorants may be a pigment, a dye, or mixtures thereof. Non-limiting examples of pigments include titanium dioxide, zinc oxide, kaolin, mica etc. Non-limiting examples of dyes include food dyes suitable for food, drug and cosmetic applications, and mixtures thereof. Some color agents (colorants) are known as FD&C dyes. The colorants may be present in an amount ranging from about 0.0001 wt % to about 0.4 wt %, including all percentages and subranges therebetween, based on the total weight of the cleaning composition. In some embodiments, the colorants may be present in an amount ranging from about 0.001 wt % to about 4 wt %, such as 0.005 wt % to about 0.01 wt %, or from about 0.007 wt % to about 0.01 wt %, including all percentages and subranges therebetween, based on the total weight of the cleaning composition.

In addition to the aforementioned components, the cleaning composition disclosed herein may further comprises additional ingredients as recognized in the art. By way of non-limiting example, additional ingredients may include stabilizers, diluents, antioxidants, and the like.

The present disclosure may provide methods for preparing aqueous cleaning compositions disclosed herein. The method may include combining, mixing, or otherwise contacting the aqueous base or carrier, the surfactant system, the one or more viscosity modifying agents, one or more excipients, or a combination thereof disclosed herein, with one another.

The present disclosure may also provide methods for improving a cloud point of a composition, improving a stability of a cleaning composition, improving flash foam of a cleaning composition, improving cleaning ability of a cleaning composition, such, for example, by decreasing the contact angle of the cleaning composition, improving oil emulsification of a cleaning composition, improving degreasing efficacy, improving soap scum removal, improving residue removal, or a combination thereof. The method may include combining, mixing, or otherwise contacting the aqueous base or carrier, the surfactant system, the one or more viscosity modifying agents, one or more excipients, or a combination thereof disclosed herein, with one another.

The present disclosure may also provide a method for preparing a cleaning composition having a viscosity of from about 500 cP to about 1500 cP while maintaining a clear or opaque solution before and after cooling. The method may include combining a plurality of viscosity modifying agents including ethanol and a poloxamer with one another. The ethanol and poloxamer may be combined with one another in an amount of about 0.5 wt % and about 0.1 wt %, respectively, or a weight ratio of about 5:1.

Further disclosed herein are methods of cleaning a substrate using the cleaning composition disclosed herein. In certain embodiments, the method comprises the step of applying the cleaning composition to a substrate; and optionally wiping the composition across the substrate. The application step may be performed in any manner that will deliver a sufficient amount of the cleaning composition to the substrate. Examples of such application step include spraying a portion of the surface with the cleaning composition from a spray bottle, spraying a portion of the surface with the cleaning composition from an aerosol can, pouring onto a portion of the surface the cleaning composition from a bottle, and like. Under one embodiment, the application step delivers the cleaning composition to a portion of the substrate which the user desires to clean. Under one embodiment, the application step delivers the cleaning composition to all of the substrate which is desired to be cleaned. In certain embodiments, the cleaning composition a concentrate that may be mixed with water to prepare a diluted solution for application to the surface, and in certain embodiments, the cleaning composition may be applied directly to the surface (or to a sponge, towel, or the like) without further dilution.

The optional wiping step may be performed to provide a coating of the cleaning composition to the entire substrate which the user desires to clean. Further, the wiping step is performed to remove the cleaning composition, along with any dirt or debris carried away by the cleaning composition. The wiping step may be performed by any suitable tool. Examples of tools used to wipe the disinfecting home care composition include a mop, rag, cloth towel, paper towel, micro fiber cloth, newspaper, paper, squeegee, sponge, brush, hand, and like.

### EXAMPLES

The examples and other implementations described herein are exemplary and not intended to be limiting in describing the full scope of compositions and methods of this disclosure. Equivalent changes, modifications and variations of specific implementations, materials, compositions and methods may be made within the scope of the present disclosure, with substantially similar results.

### Example 1—Cleaning Formulations

Three aqueous cleaning compositions are described below in Table 1. The first is a regular strength product, while the second is a 10× concentrated formulation that does not comprise viscosity modifying agents Pluronic L-44 and SD alcohol 40B. The third is an aqueous cleaning composition having a 10× concentration (as compared to Formula A) and further comprises viscosity modifying agents Pluronic L-44 and SD alcohol 40B.

TABLE 1
Cleaning composition formulations

| | Formula A | | Formula C (10x |
|---|---|---|---|
| | (regular | Formula B | conc + viscosity |
| | strength) | (10x conc) | agents |
| Ingredient | Wt % | Wt % | Wt % |
| Water | 96.92 | 69.32 | 73.37 |
| 38% Na₂O caustic soda | 0.25 | 3.81 | 3.81 |
| Citric acid (anhydrous) | 0.04 | 1.49 | 1.49 |
| Glutaraldehyde, 50% | 0.1 | 0.09 | 0.09 |
| C9-11 alcohol EO 7.5-8:1 | 0.4 | 4.5 | 4.5 |
| SO₃ LDDB sulphonic acid | 0.78 | 7.8 | 7.8 |
| Sodium Laureth | 0.66 (26%) | 6.9 (26%) | 2.45 (70%) |
| Sulfate 1EO | | | |
| Table salt | 0.15 | — | — |
| Colorant | 0.01 | 0.09 | 0.09 |
| Fragrance | 0.7 | 6-8 | 5.8 |
| Pluronic L-44 | — | — | 0.1 |
| SD Alcohol 40B | — | — | 0.5 |
| TOTAL | 100 | 100 | 100 |
| Viscosity | N/A | 2300 cp | 500-1500 cp |
| pH | 6.00-8.00 | 6.00-8.00 | 6.00-8.00 |

### Example 2—Cleaning Formulations

Multiple aqueous cleaning composition formulations were prepared as disclosed in Table 2 below.

TABLE 2
Cleaning composition formulations

| | Wt % | | | |
|---|---|---|---|---|
| | | Formula 2 | | Formula 4 |
| | Formula 1 | (Deep | Formula 3 | (10x conc. + |
| Ingredient | (Antibacterial) | Cleaning) | (Base) | viscosity agents) |
| Water | 90.52777 + | 93.36303 + | 97.0832 + | 73.787622 |
| | 0.018465 | 0.01218 | 0.444068 | |
| Linear alkyl | 1.903039 | 1.496 | 0.58344 | 5.780346 |
| benzene | | | | |
| C9-11 alcohol EO | 1 | 0.99995 | 0.4 | 4.499998 |
| 7.5-8:1 | | | | |
| 38% Na₂O Caustic | 0.924 | 0.88171 | 0.300764 | 4.21047 |
| soda (pH adjuster) | | | | |
| Fragrance | 0.7 | 0.550025 | 0.686 | 5.800002 |
| Dipropylene glycol | — | 1.5 | — | — |
| monobutyl ether, | | | | |
| soda ash, sodium | | | | |
| bicarbonate | | | | |
| Oxygen (from air) | 0.38726 | 0.32841 | 0.13794 | 1.432687 |
| 94% ethyl alcohol | — | 0.25 | — | — |
| Sulfur (molten) | 0.259466 | 0.22257 | 0.093387 | 0.955436 |
| Xanthan gum | — | 0.200025 | — | |
| C12-16 alcohol EO | — | 0.19164 | — | 1.230654 |
| 1:1 | | | | |
| Citric acid (opt. | 2.27 | 0.003 | 0.036974 | 1.49 + |
| 50%) or 88% lactic | | | | 0.02934 |
| acid | | | | |
| Preservative | — | 0.0005 | 0.000329 | — |
| (CIT/MIT, | | | | |
| isothiazolinone | | | | |
| mixture) | | | | |
| Colorant | 0.01 | 0.00048 + | 0.0088 | 0.088 |
| | | 0.00048 | | |
| Sodium chloride | 2 | — | — | — |
| C12-C14 alcohol | — | — | 0.105923 | — |
| (Preservative) | — | — | 0.099 | 0.093 |
| Glutaraldehyde, | | | | |
| 50% | | | | |
| Ethylene oxide | — | — | 0.019974 | — |
| Potassium | — | — | 0.000113 | — |
| hydroxide | | | | |
| 99% acetic acid | — | — | 0.000088 | — |
| SD alcohol 40B | — | — | — | 0.5 |
| Pluronic L-44 | — | — | — | 0.1 |
| Hydrogen | — | — | — | 0.002445 |
| peroxide, 32% | | | | |
| Total | 100 | 100 | 100 | 100 |

Next, a formulation similar to Formula 3 (base) but having twice the concentration (2×) of the surfactant system was prepared and designated Formula 3a. Formula 4 (10×) was diluted to a 1× surfactant system concentration and designated Formula 4a. Formula 2 (Deep cleaning) was diluted to 1/4 and 1/8 strength formulations and designated Formula 2a and Formula 2b, respectively. In total, 8 formulations (1, 2, 2a, 2b, 3, 3a, 4, and 4a) were prepared and tested for degreasing performance, soap scum removal, residue removal, and foam profile, as discussed in the examples below.

### Example 3—Degreasing Performance

The 8 formulations disclosed above in Example 2 were evaluated for the degreasing performance. Grease is a type of soil that may be difficult to remove due to its hydrophobic nature, presenting a high interfacial tension with water and a high affinity to hard surfaces, such as formica. The purpose of the testing described herein was to quantitatively determine the percent of effectiveness obtainable with the above-described formulations when a white formica tile soiled with grease was cleaned with a sponge containing the formulation applied thereto.

The test grease comprised 79.9% cyclohexane solvent, 15% beef tallow, 5% hydrogenated tallow, and 0.10% red dye. White formica tiles (n=24) were used for each of the formulations tested. The tiles were cleaned with alcohol and paper towels, and initial measurements were taken with a spectrophotometer (Byk-Gardner Spectroguide) before soiling, with an average of 3 readings on each quarter of the tile. Tiles were then stained with the dyed grease, using roller equipment to spread the grease uniformly on the tile, and the tiles were dried.

Next, 3.0 mL of the tested formulation was applied to a sponge, and the product homogenously spread. Abrasion equipment was set to apply the product to the tile with 100 g of weight to provide appropriate pressure for 5 strokes. The tile was then rinsed with tap water and dried at room temperature. The dry tiles were measured with the spectrophotometer, and the percent degreasing efficacy was calculated using the following formula:

$$\% Efficacy = \frac{LAfter cleaning - LAfter soiling}{LBefore cleaning - LAfter soiling} * 100$$

The results are shown below in Table 3.

TABLE 3
Percent efficacy of cleaning formulations

| | | | | Grouping with Tukey | | |
|---|---|---|---|---|---|---|
| | | Standard | | Method and 95% | | |
| Formulation (n = 24) | Mean | Deviation | 95% CI | Confidence* | | |
| #1 (Antibacterial) | 62.60 | 20.53 | (55.44, 69.75) | A | | |
| #2 (Deep cleaning) | 60.73 | 16.99 | (53.57, 67.88) | A | | |
| #2a (Deep cleaning, | 8.62 | 6.39 | (1.42, 15.77) | | | C |
| ¼ conc) | | | | | | |
| #2b (Deep cleaning, | 7.04 | 3.95 | (−0.11, 14.20) | | | C |
| ⅛ conc) | | | | | | |
| #3 (Base) | 14.14 | 10.08 | (6.98, 21.29) | | | C |
| #3a (Base, 2x) | 33.38 | 19.22 | (26.23, 40.54) | | B | |
| #4 (10x conc) | 59.07 | 31.11 | (51.92, 66.23) | A | | |
| #4a (10x conc, | 31.55 | 17.90 | (24.39, 38.71) | | B | |
| diluted to 1x) | | | | | | |

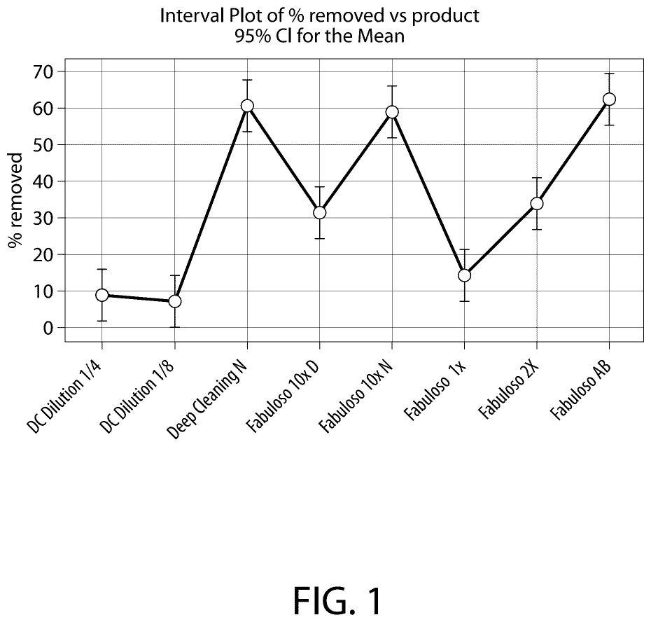

As shown in FIG. 1, Formulation #4 having a 10× concentration and viscosity agents effectively removed grease. There was no significant difference between the degreasing efficacy of Formulation #1 (antibacterial), #2 (deep cleaning), and #4 (10×) when applied without dilution. When Formulation #1 was diluted to the same strength (1× concentration) as Formulation #3, it demonstrated a better performance, having parity of performance with Formulation #3a (2× concentration).

### Example 4—Soap Scum Removal

Soap scum removal was evaluated using the 8 formulations as described in Table 2 of Example 2. Soap scum is a white, chalky residue of dirt, soap, and mineral deposits that may appear as a white or gray filmy layer that covers the surface of showers, sinks, and bathtubs. Soap scum forms when the fatty oil- or grease-based ingredients in soaps react with magnesium and calcium stearate minerals in the water. In this example, the percent efficacy for soap scum removal was quantitatively determined for black ceramic tiles soiled with artificial soap scum and then cleaned with a cleaning formulation applied to a sponge.

In this example, the soap scum mixture contained 86.81% ethanol, 5% calcium stearate, and 8.19% deionized water. Black ceramic tiles (n=24) were used for each of the formulations tested. The tiles were cleaned with alcohol and paper towels, and initial measurements were taken with a spectrophotometer (Byk-Gardner Spectroguide) before soiling, with an average of 3 readings on each quarter of the tile. Tiles were then stained with the soap scum residue, using roller equipment to spread the soap scum residue uniformly on the tiles, and the tiles were dried.

Next, 2.5 mL of the tested formulation was applied to a sponge, and the product homogenously spread. Abrasion equipment was set to apply the product to the tile for 30 strokes. The tile was then rinsed with tap water and dried at room temperature. The dry tiles were measured with the spectrophotometer, and the percent soap scum removal efficacy was calculated using the following formula:

$$\% Removal Efficacy = \frac{LAfter cleaning - LAfter soiling}{LBefore cleaning - LAfter soiling} * 100$$

The results are shown below in Table 4.

TABLE 4
% Soap Scum Removal Efficacy

| | | | | Grouping with Tukey | | | | |
|---|---|---|---|---|---|---|---|---|
| | | Standard | | Method and 95% | | | | |
| Formulation (n = 24) | Mean | Deviation | 95% CI | Confidence* | | | | |
| #1 (Antibacterial) | 8.86 | 2.5 | (7.97, 9.76) | A | | | | |
| #2 (Deep cleaning) | 8.07 | 1.98 | (7.18, 8.96) | A | B | | | |
| #2a (Deep cleaning, ¼ conc) | 7.90 | 2.49 | (7.01, 8.79) | A | B | C | | |
| #2b (Deep cleaning, ⅛ conc) | 2.28 | 0.95 | (1.39, 3.18) | | | | | E |
| #3 (Base) | 5.86 | 2.30 | (4.96, 6.75) | | | | D | |
| #3a (Base, 2x) | 6.76 | 2.71 | (5.87, 7.65) | | B | C | D | |
| #4 (10x conc) | 7.72 | 2.12 | (6.83, 8.62) | A | B | C | D | |
| #4a (10x conc, diluted to 1x) | 6.01 | 2.21 | (5.11, 6.90) | | | C | D | |

*Means that do not share a letter are significantly different.

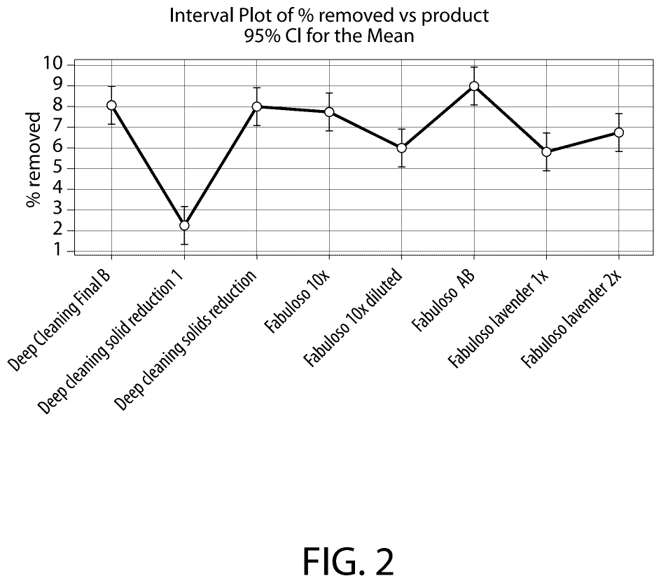

As shown in FIG. 2, Formulation #4 removes soap scum and does not show a significant difference in soap scum removal from other formulations, with the exception of Formulation #2b.

### Example 5—Residue Removal

Residue removal efficacy of the various cleaning formulations was evaluated. When cleaning a surface, streaks usually come from a combination of possible residues in the cleaning formulation and existing dirt on the surface. Although residues or streaks can be detected by the human eye, this type of visual evaluation depends on the reflection and when light bounces off of the surface. If the surface is smooth and shiny (e.g., glass or polished metal), the light will reflect at the same angle as it hits the surface, which is called specular reflection. In contrast, diffuse reflection is when light hits an object and reflects in multiple different directions. This may happen when a surface is rough and not as smooth. In this example, residues left behind after cleaning a surface were quantitatively evaluated on a scale of from 1 to 10, wherein a 0 indicates more residues and a 10 indicates no significant residues.

As cloth wiping of a surface often generates streaks, in order to simulate this wiping, the whip of a mechanical kitchen robot was replaced by a pad. A cloth impregnated with the tested formulation was then fixed on the pad, and the simulation of wiping on the surface was started. After the surface was dry, an evaluation of the presence of streaks was conducted by trained panelists. Black polymethyl methacrylate (PMMA) tiles (n=4). In this example, the seven formulations tested included Formulation #1 (antibacterial), Formulation #2 (Deep cleaning), Formulation #3 (base), Formulation #3a (2× base), Formulation #4 (10× concentration), Formulation #4a (10× diluted to 1×), and a dilution of Formulation #3 (base) that was diluted to 10% (hereinafter Formulation #3b). A placebo was also tested. The results are shown in Table 5 below.

TABLE 5
Residue Removal Efficacy

| | | | | Grouping with Tukey | | |
|---|---|---|---|---|---|---|
| | | Standard | | Method and 95% | | |
| Formulation (n = 24) | Mean | Deviation | 95% CI | Confidence* | | |
| #1 (Antibacterial) | 1.46 | 0.41 | (0.84, 2.09) | | | C |
| #2 (Deep cleaning) | 2.00 | 0.62 | (1.38, 2.62) | | | C |
| #3 (Base) | 4.75 | 0.55 | (4.13, 5.37) | | B | |
| #3a (Base, 2x) | 4.71 | 0.52 | (4.09, 5.34) | | B | |
| #3b (Base, 10%) | 7.47 | 1.04 | (6.84, 8.09) | A | | |
| #4 (10x conc) | 1.57 | 0.37 | (0.95, 2.19) | | | C |
| #4a (10x conc, diluted to | 3.61 | 0.40 | (2.98, 4.23) | | B | |
| 1x) | | | | | | |
| Placebo | 8.25 | 0.65 | (7.63, 8.74) | A | | |

*Means that do not share a letter are significantly different.

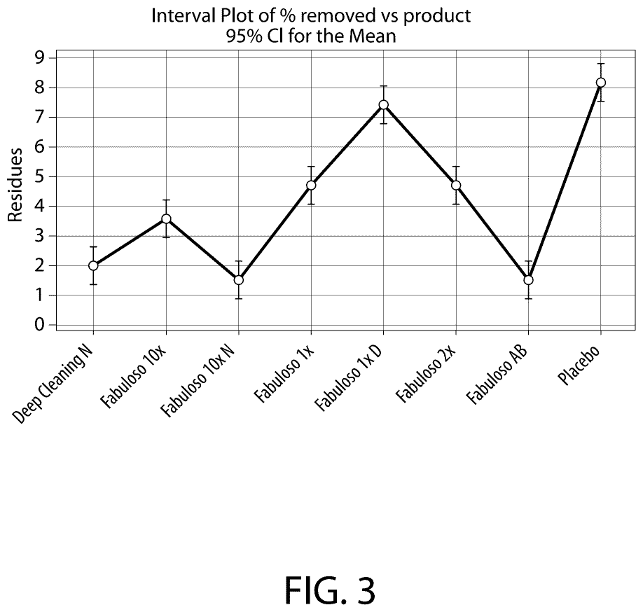

As shown in FIG. 3, Formulation #4 left more residues than other formulations, but there was no significant difference between Formulation #4 and Formulation #2. Moreover, Formulation #4a left less residue than any of Formulations #1, #2, or #4.

### Example 6—Foam Profile

The foam profile of various cleaning formulations was evaluated to determine both foam generation and further collapse in both neat and diluted formulations. Certain formulations are based on high-foaming anionic surfactants. They may be capable of maintaining adequate levels of foam throughout the cleaning process and possess sufficient emulsifying power to handle different greasy soils. Foam is known to contain a high volume fraction of gas dispersed in a liquid, wherein the liquid forms a continuous phase. “Wet” foams with a high water content, e.g., immediately after the formation of the foam, may have more or less spherical bubbles. In order to generate foam, surfaces of liquid films tend to be stabilized by layers of surfactants, polymers, and/or particles. In this example, the profile and behavior of the foam generated by induced oscillation in cylinders containing various cleaning formulations was evaluated.

The following formulations (as specification in Example 2) were evaluated: Formulation #1, Formulation #2, Formulation #2 diluted to 3.0% final concentration (hereinafter Formulation #2c), Formulation #3, Formulation #3a, Formulation #4, and Formulation #4a.

Dilutions were prepared of the testing samples to 2.5% concentration using 300 ppm of hard water as the diluent. Samples were randomized considering the four positions of the foam shaker, ensuring each formulation was tested in every position of the shaker. 100 mL of the tested formulations was added to test tubes, and the test tubes were oscillated in the foam shaker at 30 RPM (40 oscillations). The equipment was stopped and the foam volume measured (i.e., time equals zero). The foam volume was then measured every minute for six minutes, e.g., 7 total measurements.

For Formulation #2 and Formulation #2c, the foam volume at each time measurement for each sample was 400 mL, and for Formulation #4, the foam volume at each measurement for each sample was 0 mL. The results for Formulations #1, #3, #3a, and #4a are shown below in Table 6.

TABLE 6
Foam volume of cleaning formulations

| | Time | Average from 4 |
|---|---|---|
| Formulation | (min) | positions |
| Formulation #1 | 0 | 206 |
| | 1 | 205 |
| | 2 | 205 |
| | 3 | 205 |
| | 4 | 205 |
| | 5 | 205 |
| | 6 | 204 |
| Formulation #3 | 0 | 400 |
| | 1 | 400 |
| | 2 | 389 |
| | 3 | 330 |
| | 4 | 220 |
| | 5 | 128 |
| | 6 | 64 |
| Formulation #3a | 0 | 400 |
| | 1 | 400 |
| | 2 | 400 |
| | 3 | 365 |
| | 4 | 278 |
| | 5 | 189 |
| | 6 | 140 |
| Formulation #4a | 0 | 400 |
| | 1 | 400 |
| | 2 | 383 |
| | 3 | 338 |
| | 4 | 230 |
| | 5 | 120 |
| | 6 | 73 |

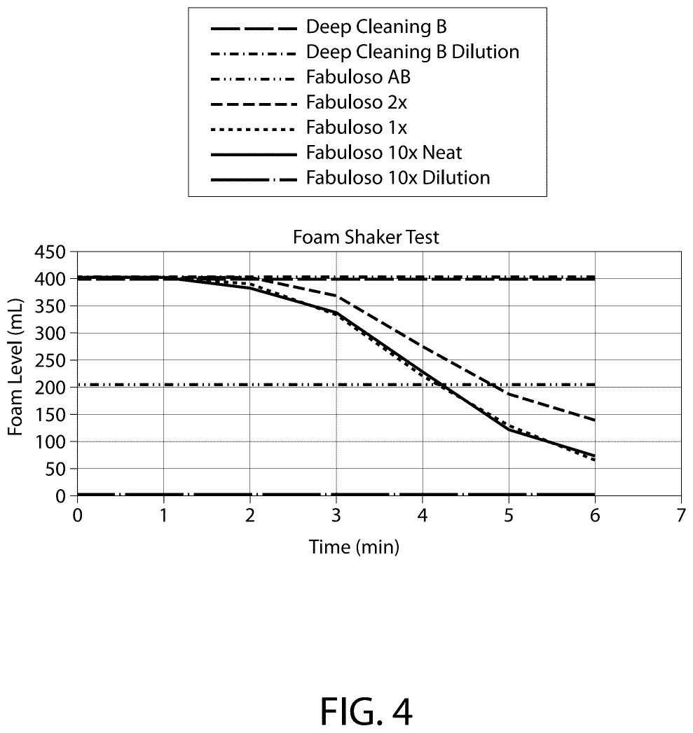

As shown FIG. 4, the foam produced by both Formulations #2 and #2c, as well as Formulation #1, remained stable during the period of testing. Formulation #4 did not generate foam, and the foam generated by Formulation #4a decreased consistently during the testing period.

### Example 7—Fragrance Evaluation

The fragrance of multiple lavender-scented cleaning formulations was evaluated, including for Formulation #3, Formulation #3a, and Formulation #4, as described in Example 2. Fragrance was evaluated on a scale of 1 to 5, as follows: 1=very low intensity; 2=low intensity; 3=medium intensity; 4=strong intensity; and 5=very strong intensity. Fragrance was measured at times periods of 0, 2, 6, and 24 hours. Dilutions of each formulation were prepared as either 1× (60 g of formulation in 1 gallon of water) or 10× (6 g of formulation in 1 gallon of water). The results are shown below in Table 7.

TABLE 7
Fragrance performance

| | Neat | Diluted | 0 hrs | 2 hrs | 6 hrs | 24 hrs |
|---|---|---|---|---|---|---|
| Formulation #3 | 4.2 | 3.8 | 3.7 | 3.5 | 3.2 | 2.8 |
| Formulation #3a | 4 | 3.6 | 3.7 | 3.4 | 3.0 | 2.6 |
| Formulation #4 | 5 | 4 | 3.8 | 3.6 | 3.4 | 3.1 |

As shown in Table 7, Formulation #4 had a significantly higher performance both initially and over time, including at 24 hours.

### Example 8—Micro Robustness and Accelerated Stability

Formulation #4 as described in Example 2 above was subjected to micro robustness and accelerated stability testing. For the micro robustness testing, it was determined that samples of Formulation #4 having both lavender and lemon fragrance met or exceeded the threshold micro robustness index of >0.85.

For stability testing, the pH, turbidity, color, odor, and appearance were monitored for both lavender and lemon samples of Formulation #4 at time periods of 0, 1, and 2 weeks. The results are shown below in Table 8. Both formulations passed the stability testing.

TABLE 8
Stability Testing Results

| | Formulation #4 Lavender | | | Formulation #4 Lemon | | |
|---|---|---|---|---|---|---|
| | 0 weeks | 2 weeks | 4 weeks | 0 weeks | 2 weeks | 4 weeks |
| pH | 6.78 | 6.23 | 6.15 | 7.05 | 6.34 | 6.26 |
| Turbidity | None | None | None | None | None | None |
| Color/odor/appearance | Purple, | Purple, | Purple, | Yellow, | Yellow, | Purple, |
| | lavender | lavender | lavender | lemon | lemon | lavender |
| | odor, | odor, | odor, | odor, | odor, | odor, |
| | slightly | slightly | slightly | slightly | slightly | slightly |
| | opaque | opaque | opaque; | opaque | opaque | opaque; |
| | | | slight | | | slight |
| | | | separation of | | | separation of |
| | | | fragrance | | | fragrance |
| | | | (whitish | | | (whitish |
| | | | liquid) | | | liquid) |

The present disclosure has been described with reference to exemplary implementations. Although a limited number of implementations have been shown and described, it will be appreciated by those skilled in the art that changes may be made in these implementations without departing from the principles and spirit of the preceding detailed description. It is intended that the present disclosure be construed as including all such modifications and alterations insofar as they come within the scope of the appended claims or the equivalents thereof.

What is claimed is:

1. An aqueous cleaning composition comprising:
a surfactant system comprising a plurality of surfactants dispersed in an aqueous base, the plurality of surfactants comprising at least one anionic surfactant and at least one nonionic surfactant; and
a plurality of viscosity modifying agents, the viscosity modifying agents comprising ethanol, a poloxamer, or a combination thereof.

2. The aqueous cleaning composition of claim 1, wherein the at least one anionic surfactant comprises an alkyl sulfonate, an alkyl ethoxy sulfate, a salt thereof, or a combination thereof.

3. The aqueous cleaning composition according to claim 2, wherein the alkyl sulfonate comprises sodium dodecyl benzene sulfonate (DDBS).

4. The aqueous cleaning composition according to claim 2, wherein the alkyl ethoxy sulfate or salt thereof comprises sodium lauryl ether sulfate (SLES).

5. The aqueous cleaning composition according to claim 1, wherein the at least one anionic surfactant is present in the composition in an amount ranging from about 1 wt % to about 20 wt %, based on the total weight of the aqueous cleaning composition.

6. The aqueous cleaning composition of claim 3, wherein the DDBS is present in an amount of from about 1 wt % to about 15 wt %, based on the total weight of the aqueous cleaning composition.

7. The aqueous cleaning composition of claim 4, wherein the SLES is present in an amount of from about 0.1 wt % to about 10 wt %, based on the total weight of the aqueous cleaning composition.

8. The aqueous cleaning composition according to claim 1, wherein the at least one nonionic surfactant comprises a reaction product of a C9-C15 or a C9-C11 alkanol and 2.5 to 10 moles of ethylene oxide, a reaction product of a C12-C13 alkanol and 6.5 moles of ethylene oxide, a reaction product of a C12-C15 alkanol and 12 moles of ethylene oxide, or a reaction product of a C14-C15 alkanol with 13 moles ethylene oxide.

9. The aqueous cleaning composition according to claim 1, wherein the at least one nonionic surfactant is present in in the composition in an amount ranging from about 1 wt % to about 10 wt %, based on the total weight of the aqueous cleaning composition.

10. The aqueous cleaning composition according to claim 1, wherein the surfactant system comprises a combination of sodium lauryl ether sulfate (SLES), sodium dodecyl benzene sulfonate (DDBS), and a reaction product of a C9-C11 alkanol ethoxylated and 8 moles of ethylene oxide.

11. The aqueous cleaning composition according to claim 1, further comprising at least one fragrance.

12. The aqueous cleaning composition according to claim 11, wherein the at least one fragrance is present in an amount ranging from about 0.5 wt % to about 10 wt %, based on a total weight of the cleaning composition.

13. The aqueous cleaning composition according to claim 1, wherein the aqueous cleaning composition is free of or substantially free of an amphoteric surfactant.

14. The aqueous cleaning composition according to claim 1, wherein the ethanol is present in an amount of from about 0.2 wt % to about 1 wt %, based on the total weight of the aqueous cleaning composition.

15. The aqueous cleaning composition according to claim 1, wherein the poloxamer is present in an amount of from about 0.01 wt % to about 1 wt %, based on the total weight of the aqueous cleaning composition.

16. The aqueous cleaning composition according to claim 1, wherein the ethanol and the poloxamer are present in a weight ratio of from about 4:1 to about 13:1.

17. The aqueous cleaning composition of claim 1, further comprising at least one pH modifier.

18. The aqueous cleaning composition according to claim 17, wherein the at least one pH modifier is chosen from caustic soda, citric acid, or a combination thereof.

19. The aqueous cleaning composition according to claim 1, having a viscosity measured at about 25° C. of from about 500 cP to about 1500 cP.

20. A method for preparing the aqueous cleaning composition of claim 1, the method comprising contacting the aqueous base, the surfactant system, and the viscosity modifying agents with one another.
